(19) United States
(12) Patent Application Publication
(10) Pub. No.: US 2006/0088811 A1
(43) Pub. Date: Apr. 27, 2006

(54) Modified multiple-choice testing system using computer and the method of same

(76) Inventors: Joo Yong Park, Seoul (KR); Kung Rok Nam, Seoul (KR)

Correspondence Address: David J Simonelli;Clark Hill, 500 Woodward Avenue, Suite 3500, Detroit, MI, 48226-3435, US

(21) Appl. No.: 10/514,615

(22) PCT Filed: May 17, 2003
(86) PCT No.: PCT/KR03/00986

§ 371 Date: Nov. 16, 2004

(30) Foreign Application Priority Data
May 17, 2002 (KR) 10-2002-27266

(51) Int. Cl. G09B 7/00

(52) U.S. Cl. 434/362

(57) ABSTRACT

The present invention relates to a modified multiple choice testing system using the computer and the method of the same. The test questions are displayed on the screen without the options. The options of the question are presented on the screen contingent upon the student's mouse click. They remain on the screen for a pre-determined duration. The student is allowed to make a selection within that time period. When the time is over, the options disappear from the screen and the test question type test taker can no longer answer the question. This invention will serve as an accurate and reliable assessment tool.

### FIELD OF THE INVENTION

The present invention relates to a system and a method that offer a test and an assessment to a test taker using a computer. More particularly, the present invention relates to a system and a method that provide more accurate and reliable assessment of a test taker's abilities by offering modified multiple-choice tests to the test taker in an attempt to combine the merits of the multiple-choice tests with those of the short answer tests using computers.

### BACKGROUND OF THE INVENTION

Testing is the most universal means of examining what one has learned and of selecting those with superior knowledge among other people.

Generally such tests can be divided into following three types: multiple-choice tests where questions are presented with options corresponding to each question and a test taker has to choose an answer among the options; short answer tests where a test taker has to write a simple answer to given questions; and essay tests where a test taker writes an essay in response to given questions.

The essay tests are very useful in that they can measure degree of a test taker's knowledge; however, it takes a long time for a grader to read and understand answers written by the test taker. Furthermore, the same answers can be given different scores depending on the grader because the grading is subjective.

The short answer test scores unlike those of the essay tests are relatively unaffected by a grader. Also, a test taker can only respond when he knows the exact answer. Therefore, it is very unlikely for him to get the right answer by guessing. However, the grader has to examine each response sheet and thus, the grading takes a long time.

In the multiple-choice tests, a test taker chooses an answer among given options for each question. Often the options are numbered on OMR cards and the test taker records a corresponding number. Because a computer can be used to grade the test taker's responses, grading takes a very short time, and the test taker can receive his score right after taking the test. However, because multiple-choice tests involve choosing an answer among given options, it is possible for the test taker to guess the right answer by just considering the options. Moreover, multiple-choice testing delimits the test taker's range of thinking because they do not have to generate their own ideas. Therefore, the multiple-choice tests are limited in discriminating among test takers.

Among these various types of tests, the multiple-choice tests continue to be popular because of the convenience in grading.

In recent years, with rapid development and spread of computers, computerized educational assessment and psychological testing are increasing throughout the world. Not only are computers used for grading, but they are also used to present questions. Some questions are presented using multi-media such as pictures, voices and animation on the computer screen. Most recently, CAT (Computer Adaptive Testing) has been introduced. In CAT, when a test taker answers a question, the next question given to him depends on whether he got the right answer or not. This helps to determine whether the test taker knew the correct answer or whether he was just guessing. The level of the questions is determined according to the performance of the test taker. This kind of testing allows the test giver to assess degree of knowledge of the test taker with relatively a few questions. However, this method calls for a large question bank and the test giver has to go through the cumbersome task of assigning difficulty level for each question.

Furthermore, this computerized testing method cannot get rid of the problem of guessing from the options.

### SUMMARY OF THE INVENTION

Accordingly, the present invention has been made in view of the above problems, and it is an object of the present invention to provide a modified multiple-choice testing system and the method thereof that can combine the merits o the multiple-choice tests with those of the short answer tests by forcing the test taker to solve a problem like a short answer question but to respond in a multiple-choice test using the options presented at the last moment.

Another object of the present invention is to provide a modified multiple-choice testing system and the method thereof that can effectively discriminate among test takers owing to their being unable to guess the answer from only seeing options by offering options corresponding a question of a multiple-choice-problem to the test takers for a short time.

Still another object of the present invention is to provide a modified multiple-choice testing system and the method thereof that can enable the test graders to assess the test takers' ability with relatively a few questions.

Still another object of the present invention is to provide a modified multiple-choice testing system and the method thereof for an impartial test since the scoring process in the project invention is computerized.

According to one aspect of the present invention, a computerized modified multiple-choice testing system comprises an assessment system, a test taker client system and a network. The assessment system comprises an assessment database for storing test question information including test questions and answer key, a test taker database for storing log-in information including the test taker's citizen ID number and test ID number, an operation database for storing programs regarding processing of the test questions and a server system for transferring and receiving data to allow the test taker to take the test. The test taker client system comprises a display module for being installed in the computer and presenting test questions and options on the computer screen, a first storage mechanism for receiving the test questions and options from the assessment system and storing them, a test operation module for displaying the multiple options to the selected question for a limited amount of time after the test question is selected, and a response storage module for recording the test taker's response to the test questions. The network, e.g. Internet, is for data communication between the assessment system and the test taker client system.

According to another aspect of the present invention, a computerized modified multiple-choice testing method is provided. The steps of the method comprise the first step of receiving and storing the test questions and multiple options from the assessment system, and displaying the test questions, the second step of displaying the options to a question for a preset amount of time when the test taker selects a test question among the displayed test questions and of recording the response to the test question in the test taker client system, and the third step of transmitting the test taker's responses to said assessment system that administers the test through a network when the test completion signal is given.

The test taker is first given the question only so that he has to solve it as if he were solving a short answer problem. When the test taker selects a question that he would like to answer, the options to the question appear on the computer screen for a short time. The test taker has to choose an answer among the options within the given time.

The merits of the present invention is as follows:

First, it obviates the common criticism against multiple-choice testing, which is that it delimits the test takers' range of thinking, because the test takers have to generate possible answers by themselves. Second, it can reduce the use of guessing strategies, because the options are presented for a short time. Third, scoring is easy and objective just as in the multiple-choice format. Fourth, it is relatively easy for the test developers to make the foils because the options are presented for a short duration. Furthermore, it enhances memory retention of the tested material more than the multiple-choice testing. It is widely known that retrieval difficulty enhances memory retention.

### BRIEF DESCRIPTION OF THE DRAWINGS

Further objects and advantages of the invention can be more fully understood from the following detailed description taken in conjunction with the accompanying drawings in which:

FIG. 1 is a schematic diagram of the computerized modified multiple-choice testing system according to the present invention;

FIG. 2 is a flowchart that shows the process of the computerized modified multiple-choice testing method according to the present invention;

FIG. 3 is a display on the client computer screen that shows questions provided for a test taker client system according to an embodiment of the present invention; and

FIG. 4 is a display on the client computer screen that shows options that appear for a preset amount of time according to an embodiment of the present invention.

### DETAILED DESCRIPTION OF THE INVENTION

The present invention will now be described in detail in connection with preferred embodiments with reference to the accompanying drawings.

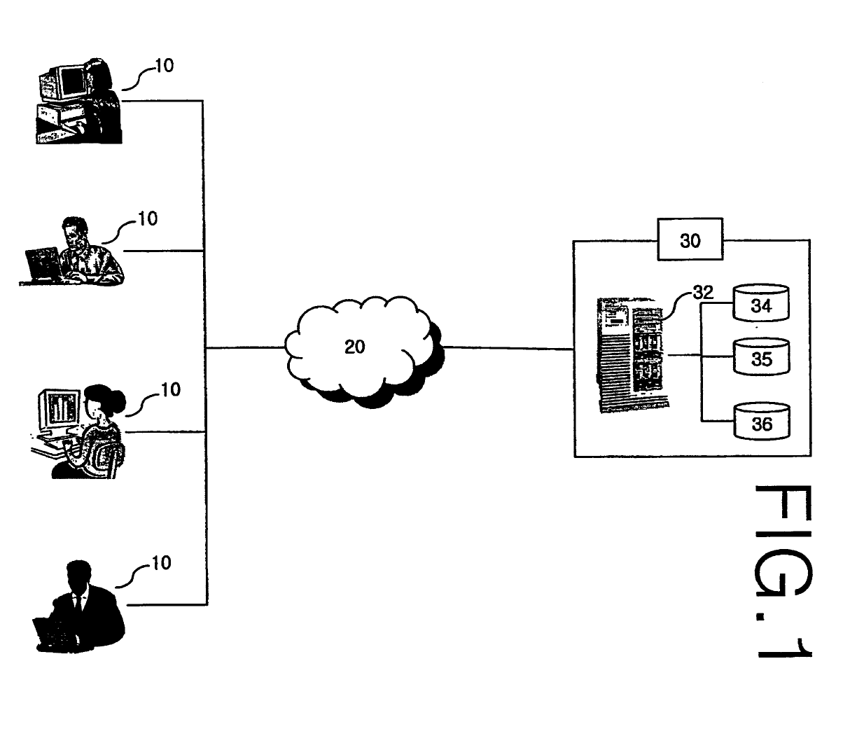

FIG. 1 shows a schematic diagram of the subject computerized modified multiple-choice testing system. The system comprises one or more test taker client systems 10 that allow the test questions to be displayed so that the test taker can take the test on a computer of the test taker client system, a network for data communication through which transfers the test questions and grades the test taker's test results, and an assessment system 30 connected to the test taker client system 10 by the network 20.

Each of the test taker client system 10 according to the present invention comprises a computer that the test taker uses to take the test. The test taker client system 10 receives test questions from the assessment system 30 so that the test taker can access them, records the test taker's responses and transfers them to the assessment system 30. Furthermore, the test taker client system 10 receives the test taker's test scores from the assessment system 30 so that the test taker can view it.

In order to present the test questions and options on the computer screen, the test taker client system 10 has a display module. The display module is installed in the computer. Questions and options received from the assessment system 30 are stored in a first storage mechanism included in the test taker client system 10. A test operation module of the test taker client system 10 presents the given options for a limited amount of time after the test question is selected. A response storage module of the test taker client system 10 records and stores the test taker's response to the test question.

Each of the test taker client system 10 has a unique assigned number and the test taker's log-in information and the test taker client system's number is transferred to the assessment system 30 when the test taker logs in and connects to the assessment system 30.

The assessment system 30 of the present invention is connected to the test taker client system 10 through the network 20 and comprises a test taker database 34 for storing the log-in information including the test taker's citizen ID number, test ID number and the like, an assessment database 35 for storing information on the test questions, and an operation database 36 for storing operating programs of the assessment system 30. The assessment system 30 also has a server system 32 that transfers the responses given by the test taker from the test taker client system 10 and that processes the responses to assess the test.

The assessment system 30 recognizes a physical number of the computer of the test taker client system 10 and transfers the test questions and options selected by the test taker at different times for each of test taker client system 10.

The test taker client system 10 and the assessment system 30 are generally connected through a network 20 and the test taker has to take the test on a given computer terminal. However, if necessary, the assessment system 30 and the test taker client system 10 can be connected by public communication network such as Internet, and the test taker can download and install the programs needed to take the test on his desired computer and then he can take the test at a place of his choosing.

The programs stored in the operation database of the assessment system 30 include several modules or mechanisms such as a log-in processing module, a test question transmission module, a second storage mechanism and a result transmission module. The log-in processing module receives the log-in formation from the computer of the test taker client system 10 and stores it in the test taker database 34. The test question transmission module verifies the physical number or address, e.g. IP address, of the computer that the test taker used to log in and transmits the test questions and options to the computer. The second storage mechanism records the test taker's responses to generate the result and stores the test results. The result transmission module provides the test taker with the test results by using the log-in information of the test taker stored in the test taker database 34.

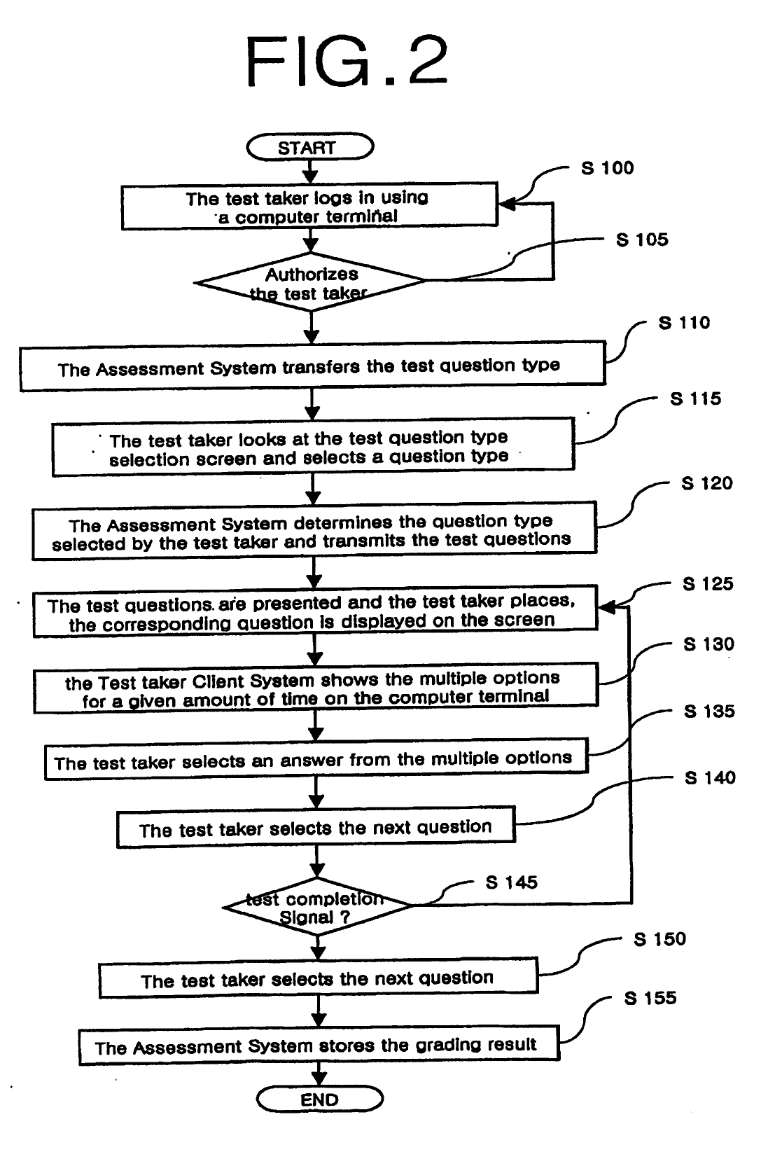

FIG. 2 is a flowchart that shows a specific process of the computerized modified multiple-choice testing method according to the present invention. A test taker can select a question that he wants to answer among the questions that are presented to him. At that time, the options corresponding to the selected question appear on the computer screen for a predetermined short time. Thus, the test taker cannot choose the right option if he did not know the correct answer already. This allows for the test giver to accurately assess the knowledge of the test taker.

Further description in reference to FIG. 2 is as follows:

At step S100, a test taker logs in using a computer of a test taker client system 10. Log-in information includes the test taker's name, the test taker number and so on. The test taker number is an identification number given to the test taker when he registers for the test. It can be substituted by the student ID number if the test is administered at school. The test taker client system 10 sends the test taker's log-in information to the assessment system 30 through the network 20. At the same time, the test taker client system 10 sends ID number of the computer. The number can be the IP address of the computer terminal or the ID number of the LAN card.

At step S105, the assessment system 30 authorizes the test taker after comparing the test taker's log-in information with the information stored in the test taker database 34 and allows the test taker to be connected to the assessment system 30. Also, it stores the ID number of the computer used by the test taker on the test taker database 34. If problem arises with the previous computer terminal, the test taker has to log-in again using another computer terminal and the test taker database 34 stores the ID number of the new computer terminal.

At step S110, the assessment system 30 transfers the test question type selection screen stored in the assessment database 35 to the test taker client system 10 when the test taker succeeds in log-in. Then the computer terminal used by the test taker displays the test question selection screen. Transferring the test question selection screen to the test taker client system 10 takes place using the ID number of the computer terminal stored in the test taker database 34. All subsequent communication between the computer and the assessment system 30 is accomplished by using the ID number of the computer terminal.

At step S115, the test taker looks at the test question type selection screen and selects a question type. The selection of the question type is optional and all the tests can be given in the same format.

At step S120, the assessment system 30 determines the question type selected by the test taker and transmits the test questions and the corresponding multiple options stored in the assessment database 35 to the test taker client system 10.

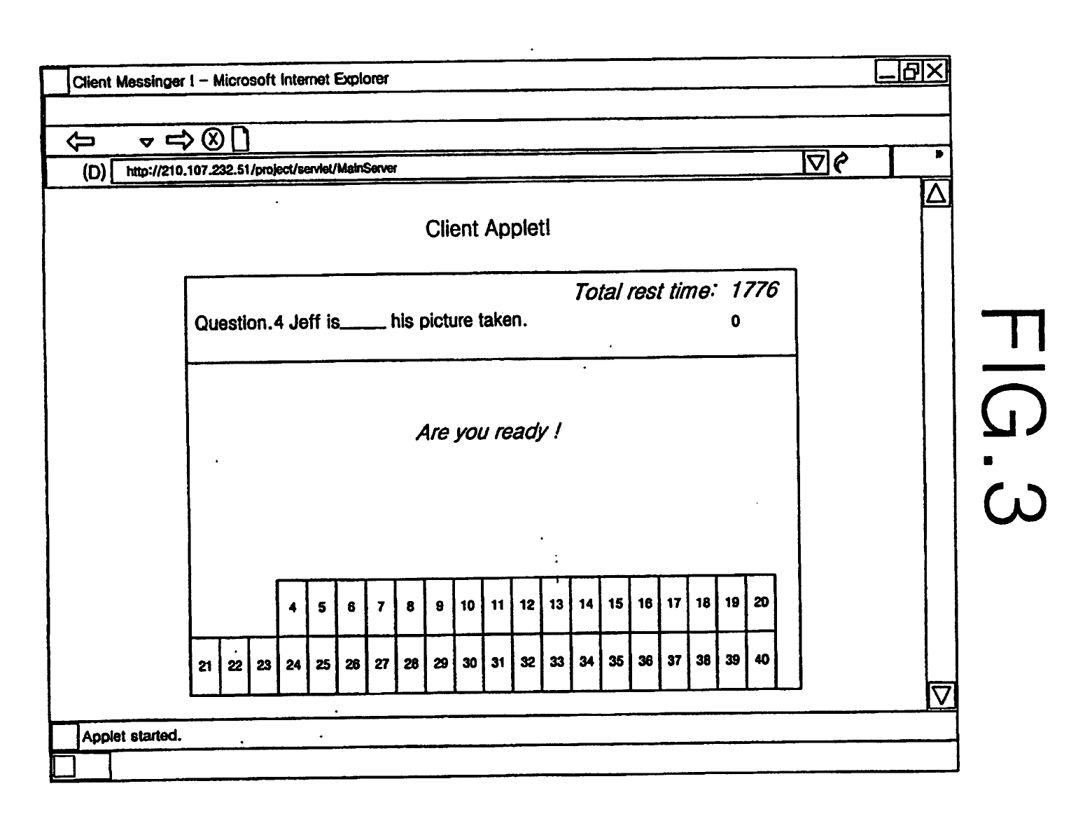

At step S125, when the test taker places the mouse on the question number, the corresponding question is displayed on the screen. The test question displayed is presented as shown in FIG. 3. The test taker can mouse over any questions before selecting a question. When the test taker selects a question, the test taker client system displays the chosen question on the computer screen.

At step S130, the test taker can request the options by entering a signal when he thinks that he is ready to answer to the displayed question. Then the test taker client system 10 shows the multiple options for a given amount of time on the computer screen. The time the options are displayed is predetermined and can be set depending on various factors such as test taker's ages and the length of the options.

At step S135, the test taker client system 10 records the test taker's response and stores it when the test taker selects an answer from the multiple options. Within the given time, the test taker can change his answer to a different option. When the options disappear, the test taker can no longer select an answer.

At step S140, the test taker client system 10 presents the next question when the test taker selects the next question using the question numbers displayed on the computer screen.

At step S145, the test taker can send the test completion signal to the assessment system 30 using the test taker client system 10 when the test taker finished solving all the questions. The test taker client system 10 no longer allows the test taker to select more questions or record an answer. Also, when predetermined testing time has passed, the assessment system 30 generates a test completion signal and sends it to the test taker client system 10. The test taker client system 10 then does not allow the test taker to select questions and does not respond to question selection signal or option enter signal. The test taker can no longer record an answer.

At step S150, when the test completion signal is generated, the test taker client system 10 requests the assessment system 30 to perform grading and sends the stored answers to the assessment system 30.

At step S155, when the assessment system 30 receives the grading request signal and the test taker's responses from the test taker client system 10, the system 30 loads the answer key data stored in the assessment database 35, assesses the test taker's responses and produces the grading result. The grading result includes each test taker's test score, results of correct or incorrect responses for each question, the average score, the highest score, the lowest score and the percentage of correct answers for each question. The assessment system 30 stores the grading result in the test taker database 10 and informs him of his test score, results of correct or incorrect responses for each question, the average score, the highest score, the lowest score and the percentage of correct answers for each question.

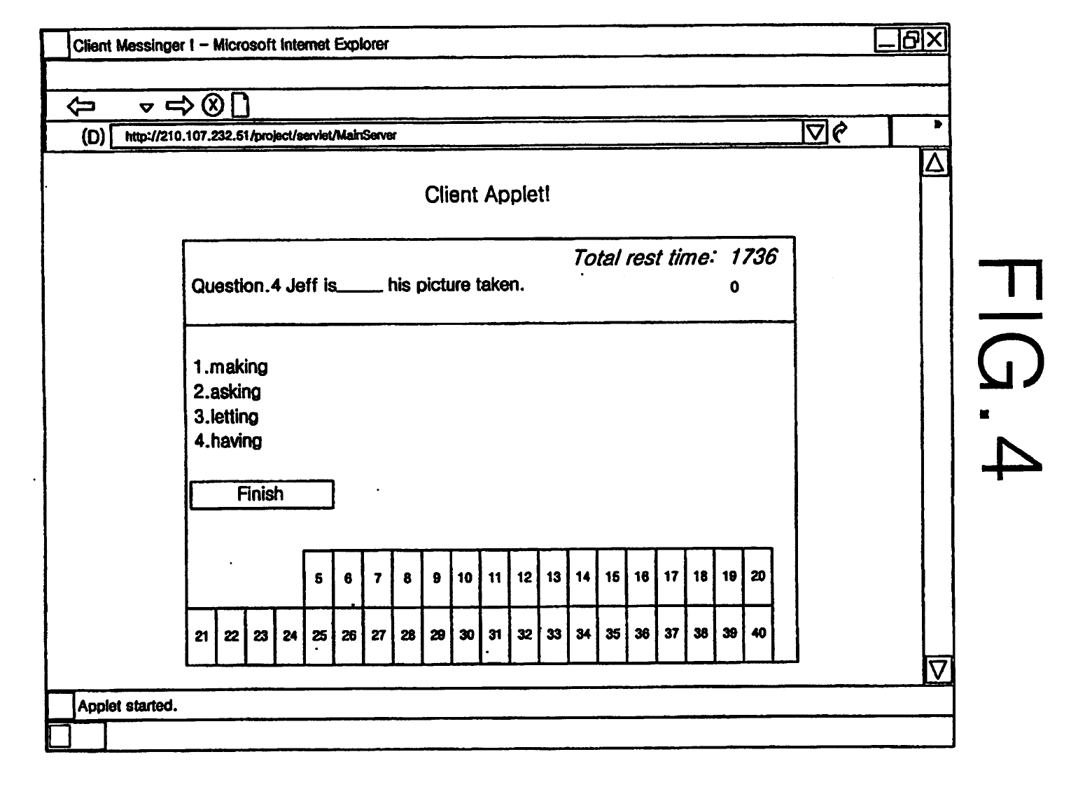

FIG. 3 shows an example of the computer screen when the selected test question is presented according to the computerized modified multiple-choice testing system. FIG. 4 shows an example of the computer screen when the test questions and options are presented according to the computerized modified multiple-choice testing system.

As shown in FIG. 3, question 4, “Jeff is ______ his picture taken” is shown on the computer screen. When the test taker thinks of a word that is appropriate for the blank, he can click on No. 4 button at the bottom of the screen. Then the options “1.making, 2.asking, 3.letting, 4.having” are displayed on the screen as shown in FIG. 4. At the same time, preset display time for the options appears on the upper right hand corner of the screen. For instance, if 20 seconds are given for question 4, then “20” is displayed and is counted down. The test taker has to select and click on an option within the predetermined 20 seconds. After 20 seconds have passed, the options disappear from the screen. The time for the options being displayed is set by the test provider after considering various factors such as test taker's ages and the length of the options.

According to the computerized modified multiple-choice system and method thereof, a test taker can only view options corresponding a question for a short time and is unable to guess an answer only from looking at the options. Unless he knows the answer, it is relatively difficult for him to select a correct answer among the given options. Therefore, the test taker can be given a multiple-choice test that has an effect of a short answer test.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A computerized modified multiple-choice testing system that provides test questions, determines test results in accordance with a test taker's responses, receives the test questions on a computer, and gives a test to the test taker using the computer, the system comprising:
an assessment system having an assessment database for storing test question information including the test questions and answer keys, a test taker database for storing log-in information including the test taker's citizen ID number and test ID number, an operation database for storing programs regarding processing of the test questions, and a server system for transferring and receiving data to allow the test taker to take the test;
a test taker client system having a display module presenting test questions and options on the computer screen, a first storage mechanism for receiving the test questions and options from the assessment system and storing them, a test operation module for displaying the multiple choices to the selected question for a limited amount of time after the test question is displayed, and a response storage module for recording the test taker's responses to the test questions; and
a network for data communication between the assessment system and the test taker client system;
wherein the programs stored in the operation database having a log-in processing module for processing the log-in information using the computer, a test question transmission module for placing the computer that the test taker used to log-in and transmitting the test questions and options to the computer, and a second storage mechanism for recording the test taker's responses, generating the test results, and storing the test results.

2. The testing system as recited in claim 1, wherein said network is Internet.

3. The testing system as recited in claim 1, wherein said assessment system further comprises a result transmission module for providing the test taker with said test results by using the log-in information of the test taker.

4. The testing system as recited in claim 1, wherein said assessment system uses an IP address of said computer in order to recognize the location of the computer.

5. The testing system as recited in claim 1, wherein said test taker client system can download the programs through said network from said assessment system.

6. A method of processing test questions that uses an assessment system for providing the test questions and determining test results in accordance with test taker's responses, and that receives the test questions on a computer and gives a test to the test taker using the computer, the method comprising the steps of:
(a) receiving and storing the test questions and multiple options from the assessment system, and displaying the test questions;
(b) displaying the options on the computer screen for a preset amount of time when the test taker selects a question among the displayed test questions, and recording the response to the test question in said test taker client system; and
(c) transmitting the test taker's responses to said assessment system that administers the test through a network when a test completion signal is given.

7. The method as recited in claim 6, wherein said step (a) further comprises displaying the selected test question on the screen when the test taker selects one of the numbers representing the test question.

8. The method as recited in claim 6, wherein said method further comprises:
(d) assessing the transmitted test taker's responses and notifying the results to the test taker.

9. The method as recited in claim 6, wherein the step (b) further comprises changing a selected option to a different option as many times as the test taker wants within the preset amount of time.
